(19) United States
(12) Patent Application Publication
(10) Pub. No.: US 2024/0216992 A1
(43) Pub. Date: Jul. 4, 2024

(54) METHOD FOR ADDITIVE MANUFACTURING OF TURBOMACHINERY PARTS

(71) Applicant: SAFRAN AIRCRAFT ENGINES, Paris (FR)

(72) Inventor: Hugo Jean-Louis SISTACH, MOISSY-CRAMAYEL (FR)

(21) Appl. No.: 18/576,901

(22) PCT Filed: Jun. 14, 2022
(86) PCT No.: PCT/FR2022/051143

§ 371 Date: Jan. 5, 2024

(30) Foreign Application Priority Data
Jul. 5, 2021 (FR) FR2107240

(51) Int. Cl. B22F 10/38; B22F 5/00; B22F 10/66; B22F 10/85; B33Y 10/00; B33Y 40/20; B33Y 50/02; B33Y 80/00

(52) U.S. Cl. CPC B22F 10/38; B22F 5/009; B22F 10/66; B22F 10/85; B33Y 10/00; B33Y 40/20; B33Y 50/02; B33Y 80/00; B22F 2998/10

(57) ABSTRACT

A turbomachine part has a primary axis and at least one inclined portion extending in a secondary direction forming a non-zero angle with the primary axis. A method for additive manufacturing of the turbomachine part includes the steps of a) for each inclined portion: a1) providing a target roughness of an outer surface of said inclined portion, a2) providing a mechanical weakening of the inclined portion, and a3) determining a maximum roughness of the outer surface of the inclined portion according to the mechanical weakening. The method also includes steps of b) determining a total maximum roughness according to the maximum roughness of the outer surface of each inclined portion, c) determining, according to the total maximum roughness, an orientation of the primary axis of the part to be manufactured with respect to a plane of a manufacturing platen of the additive manufacturing device, and d) producing the part.

### TECHNICAL FIELD OF THE INVENTION

The present invention relates to a method for additive manufacturing by melting on a powder bed, in particular for manufacturing turbomachine parts.

### PRIOR ART

It is now usual to have recourse to additive manufacturing techniques for easily and quickly producing complex parts. When it is a case of manufacturing parts made from metal alloy or from ceramic, the method of selective melting or selective sintering of powder makes it possible to obtain complex parts that are difficult to produce or cannot be produced with conventional methods such as casting, forging or machining. It is in particular possible to produce parts having cavities that are difficult to access. The aeronautical field lends itself particularly well to the use of this method.

Furthermore, such an additive manufacturing method has the advantage of being quick and not requiring any specific tooling, unlike the majority of conventional methods, which considerably reduces the costs and manufacturing cycles of the parts.

Such a method generally comprises a step during which, on a manufacturing platen, a first layer of powder of a metal, of a metal alloy or of ceramic of controlled thickness is deposited, then a step consisting in heating, with a heating means (for example a laser beam or a beam of electrons) a predefined region of the layer of powder, and proceeding by repeating these steps for each additional layer, until the final part is obtained, slice by slice. Such a method may be a method called laser beam melting or selective laser melting.

Some turbomachine parts have complex shapes and include portions inclined with respect to each other, which means that some portions of the part are inclined with respect to the manufacturing platen of the additive manufacturing device. FIG. 1 shows such an inclined portion 10 as disposed on the manufacturing platen 5, with an angle α. The successive melting of the layers 2 can cause a step effect on the outer surface 3 of the inclined part 10. This is because the melting means, for example the laser rays, are directed vertically along Z, which causes the step effect between the layers, which have a fixed thickness and not necessarily consistent with the required geometry. Furthermore, remaining powder grains may fuse with the bottom surface 4 of the inclined portion 10. These step effects depend on the angle α.

The part thus produced has relatively high roughness, which may be detrimental to the mechanical strength and service life of the part.

Furthermore, regions of the part that are in the air stream, when the part is arranged in a high-pressure portion of the turbine, require a first low maximum roughness to limit the pressure drops and boundary layer effects. While the same regions, when the part is arranged in a low-pressure portion of the turbine, can have a second maximum roughness greater than the first maximum roughness, and do not need such a low roughness.

There is a need to control the roughness of the parts produced by additive manufacturing.

For this purpose, some methods consist in measuring the roughness of the parts after manufacture thereof and reworking the machining of the surfaces of the parts to obtain a surface state in accordance with the mechanical properties necessary for the part. These additional operations are often expensive, complex and sometimes redundant.

There is a need to improve the control of the roughness of the parts produced by additive manufacturing.

### SUMMARY OF THE INVENTION

For this purpose, the present document relates to a method for additive manufacturing of a turbomachine part, said part having a primary axis and at least one inclined portion extending in a secondary direction forming a non-zero angle with the primary axis, comprising the steps:
a) for each inclined portion:
a1) providing a target roughness of an outer surface of said inclined portion,
a2) providing a mechanical weakening of said inclined portion,
a3) determining a maximum roughness of the outer surface of said inclined portion according to the mechanical weakening of said inclined portion,
b) determining a total maximum roughness according to the maximum roughness of the outer surface of each inclined portion,
c) determining, according to the total maximum roughness, an orientation of the primary axis of the part to be manufactured with respect to a plane of a manufacturing platen of the additive manufacturing device, and
d) producing the part by additive manufacturing.

The method makes it possible to obtain a part with an acceptable surface state and with the mechanical strength necessary for the functioning of the part.

The primary axis may be an axis of revolution, an axis of symmetry or an axis in a longitudinal direction of the part. The secondary direction may be along a longitudinal axis, an axis of revolution or an axis of symmetry of the inclined part.

The roughness may be the arithmetic mean roughness of the profile of the outer surface or the maximum roughness of the profile of the outer surface.

The roughness can be measured by a profile meter with or without contact, for example by a laser or visual profile meter.

Step a1) can comprise: providing a target roughness of the top outer surface of the inclined part and a target roughness of the bottom outer surface of the inclined part. The top outer surface can be opposite to the bottom outer surface with respect to a longitudinal plane of the inclined part.

Mechanical weakening, in fatigue, determined by mechanical fatigue tests at the operating temperature and under the operating conditions of the part can be dependent on the roughness, in particular the roughness of the inclined part when it is subjected to predetermined mechanical stresses. For example, the mechanical weakening may be a mechanical weakening known as LCF (standing for (“low cycle fatigue”), which corresponds to an oligocyclic fatigue with respect to known reference curves of the part. LCF mechanical weakening can be determined by mechanical fatigue tests with stress cycles applied to specimens with a low test frequency. This LCF mechanical weakening can be associated with the phenomena of thermal expansion and contraction due to the temperature to which the part is subjected.

The mechanical weakening may be a mechanical weakening known as HCF (standing for (“high cycle fatigue”), which corresponds to a vibratory fatigue of the part due to the vibration of the turbomachine. HCF mechanical weakening can be determined by fatigue tests but with a high test frequency.

Mechanical weakening may be a percentage between a fatigue curve of the part with respect to a reference curve of the part when it is not subjected to thermomechanical stresses.

The target roughness may depend, and/or may be deduced, from the function of the inclined portion or of a region of said inclined portion. The target roughness may be dependent on an aerodynamic requirement. For example, regions of the part that are designed to be arranged in an air stream, when the part is a stator vane of a high-pressure compressor of the turbomachine, can have a target arithmetic mean roughness of less than 1.6 μm. For these same regions, when the part is a nozzle of a low-pressure turbine of the turbomachine, can have a target arithmetic mean roughness of less than 3.2 μm.

Furthermore, when the inclined portion is a connection portion between two portions of the part, the target arithmetic mean roughness can be less than 3.2 μm.

The plane of the manufacturing platen can be substantially perpendicular to a direction of the laser rays used for melting the layers of the part, to improve the surface state.

The maximum roughness to be borne, during step b), can be determined according to the target roughness and the tenable roughness according to the inclination of the part being manufactured.

The method can comprise the determination of a first experimental law, said determination comprising the steps:
supplying reference specimens, each reference specimen having a primary axis and being produced by additive manufacturing, each reference specimen comprising a bottom surface turned towards the manufacturing platen of the manufacturing device forming a first angle with the primary axis and a top surface opposite to said bottom surface and forming a second angle with the primary axis,
for each reference specimen, measuring the roughness of the top surface and the roughness of the bottom surface,
obtaining said first experimental law by interpolating the roughnesses of the top surface and of the bottom surface according to the first angles and the second angles.

The first angle and the second angle may be manufacturing angles.

The first experimental law may depend on the material of the reference specimen, on the thickness of the layers deposited by additive manufacturing, on the temperature of the part for example during use of the part in an engine comprising same, on the power of the laser rays and/or on the speed of the laser rays.

The first experimental law can be obtained by a polynomial interpolation or any other adapted function.

The roughness may be a mean of roughnesses. For example, several reference specimens, having the same material, the same first angle and the same second angle, can serve for measuring the roughnesses mean. The first experimental law may comprise a first curve obtained for roughness data at standard deviations of approximately +2 of the roughnesses mean, and a second curve obtained for roughness data at standard deviations of approximately −2 of the roughnesses mean. Thus it is possible to predict the variability of the roughness for one and the same angle.

The first experimental law can be stored in a database.

The first angle and the second angle may be complementary.

Step c) can comprise determining the orientation of the primary axis of the part using the first experimental law. For example, the inverse of the first experimental law can be used according to the total maximum roughness to calculate an angle between the outer surface and the plane of the manufacturing platen.

The orientation of the primary axis can be obtained according to said calculated angle and the angle between one, or each, inclined portion and the primary axis.

Step c) may comprise determining the orientation of the primary axis of the part using a law linking the roughness and the manufacturing angle obtained by simulation.

The method can comprise a step of validating the first experimental law, comprising the steps:
producing, by additive manufacturing, at least one specimen having a primary axis and comprising an outer surface forming a test angle with the primary axis,
measuring the roughness of the outer surface,
comparing the measured roughness with a roughness calculated according to the test angle and the first experimental law.

When the measured roughness is different from the calculated roughness, the method can comprise a step of adjusting the first experimental law.

The method can comprise the determination of a second experimental law, said determination comprising the steps:
for each reference specimen, measuring the mechanical weakening and the roughness of the bottom surface and/or of the top surface,
obtaining said second experimental law by interpolating the mechanical weakenings as a function of the roughnesses.

The mechanical weakening may be a mean of mechanical weakenings. For example, several reference specimens, having the same material, the same first angle and the same second angle, can serve for measuring the mean of the mechanical weakenings.

The method can comprise, prior to measuring the mechanical weakening, the manufacture of the reference specimen by additive manufacturing.

The reference specimens used for determining the first experimental law can be different from the reference specimens used for determining the second experimental law. For example, the reference specimens for determining the second experimental law can comprise an outer surface that can be either a bottom surface or a top surface and the roughness is measured for the outer surface.

The second experimental law can be determined for various temperatures of use of the part.

Step a3) can comprise determining the total maximum roughness using the second experimental law.

Step a3) can comprise determining the total maximum roughness using a law linking the roughness and the manufacturing angle obtained by simulation.

The second experimental law can be stored in the database.

The method can comprise, for each inclined portion, the steps:
comparing the target roughness and the total maximum roughness,
when the total maximum roughness is greater than the target roughness of said inclined portion, machining said inclined portion to obtain the target roughness, subsequently to step d).

The method can comprise polishing the inclined portion or milling the inclined portion. This step makes it possible to obtain the target roughness.

The polishing may be a chemical polishing, a tribofinishing, a polishing by abrasive paste, a sanding, etc.

The method can comprise, for each inclined portion, the steps:
comparing the target roughness and the total maximum roughness,
when the total maximum roughness is greater than the target roughness of said inclined portion, modifying the dimensioning of the inclined portion by adding a thickness thereto, prior to step d).

The thickness may depend on the method for machining the part to obtain the target roughness, which may be polishing or milling of the part.

The method can comprise, for each inclined portion, the steps:
comparing the target roughness and the total maximum roughness,
when the total maximum roughness is greater than the target roughness of said inclined portion, modifying the dimensioning of the inclined portion by modifying the angle between the inclined portion and the primary axis or by modifying another dimension of the inclined portion, which may be its length, its thickness or its width.

The part can be produced by additive manufacturing by depositing a succession of layers of a powder of the material of the part with a thickness of between 20 and 60 microns, for example equal to 40 microns.

The part may be a bearing support of the turbomachine or a turbine blade of the turbomachine or a compressor blade of the turbomachine.

The present document also relates to a device comprising means for implementing the method as aforementioned.

### BRIEF DESCRIPTION OF THE FIGURES

FIG. 1, already described, shows a cross section of a part produced by additive manufacturing,

FIG. 2 shows a perspective view of a bearing support of a turbomachine,

FIG. 3a shows a perspective view of a cross-section of the bearing support of FIG. 2 and FIG. 3b a front view of the cross section of FIG. 3a,

FIG. 4 shows a block diagram of an example of a method for manufacturing the bearing support of FIG. 2,

FIG. 5 shows a block diagram of an example of determining laws characterising the surface state of parts obtained by additive manufacturing,

FIG. 6 shows reference specimens used in the method of FIG. 5,

FIG. 7 shows curves linking roughness and manufacturing angle,

FIG. 8 shows curves linking mechanical weakening and roughness,

FIG. 9 shows a perspective view of a cross-section of the bearing support after resizing thereof,

FIG. 10 shows the arrangement of the bearing support on the manufacturing platen of the additive manufacturing device.

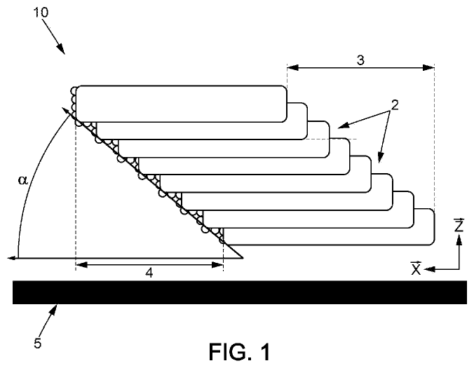

### DETAILED DESCRIPTION OF THE INVENTION

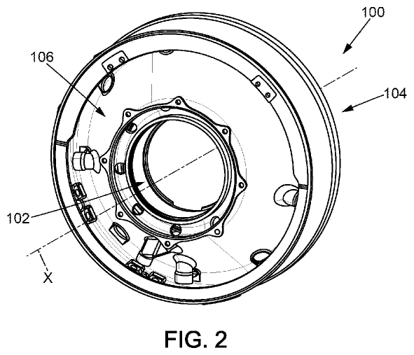

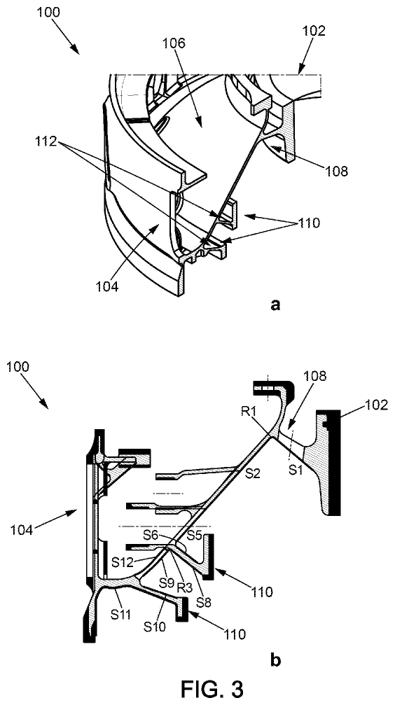

With reference to FIGS. 2 and 3, the bearing support 100 of a turbomachine that can be arranged between a rotor of the turbomachine and a rotor shaft of the turbomachine that are coaxial. For example, the bearing support 100 comprises an internal collar 102 in which the rotor shaft is mounted and an external collar 104 on which the rotor is mounted.

The bearing support 100 can be mounted at a fan, at a compressor or at a turbine of the turbomachine.

The bearing support 100 comprises a connecting wall 106 connecting the internal collar 102 to the external collar 104, which is inclined with respect to the axis X of the internal and external collars. The internal collar 102 is connected to the connecting wall 106 by an internal rib 108 that also has an inclination with respect to the axis X. The bearing support 100 can comprise other intermediate collars 110 having X as their axis and connected to the connecting wall 106 by intermediate ribs 112. The intermediate collars 110 can have axes inclined with respect to the axis X. These intermediate collars 110 are force-absorption regions between a shaft that passes at the centre of the bearing support and of the turbine that is secured on the external regions. Oil can circulate between the shaft and the bearing support.

Each of the internal rib 108 and intermediate ribs 112 has a distinct angle with the axis X. This increases the complexity of production of the bearing support 100 by conventional production machines. To remedy this, additive manufacturing methods are used to facilitate production of parts such as the bearing support 100. However, such methods do not make it possible to control the roughness of the outer surfaces, in particular of the intermediate ribs 112 and of the internal rib 108.

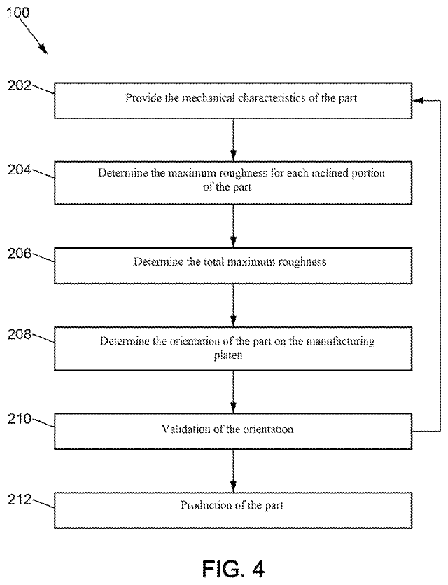

An additive manufacturing method 200, shown in FIG. 4, makes it possible to obtain turbomachine parts with controlled surface states.

Hereinafter, the method 200 is described in relation to the bearing support 100 but can be applied to any other turbomachine part, for example a turbine blade of the turbomachine or a compressor blade of the turbomachine.

The method 200 comprises a step 202 of providing characteristics of the bearing support. For example, target roughnesses and mechanical weakenings for each surface S1, S6, S8, S10 and S11 of the internal rib 108 and of the intermediate ribs 112 are provided.

Target roughnesses and mechanical weakenings are also provided for each of the surfaces S2, S5, S9 and S12 of the connecting wall 106.

The target roughnesses depend on the arrangement of the surface in question and on the aerodynamic requirement. For example, the surfaces S1, S6, S8, S10 and S11 of the internal rib 108 and of the intermediate ribs 112 can have target roughnesses of less than 3.2 μm.

The roughness is an arithmetic mean roughness of the profile measured by a profile meter with or without contact.

Alternatively, the roughness can be a maximum roughness of the profile determined by a profile meter with or without contact.

The mechanical weakening is a percentage between a fatigue curve with respect to a reference curve in the absence of thermomechanical stresses.

The mechanical weakening may be a mechanical weakening known as LCF (standing for “low cycle fatigue”) and/or a mechanical weakening known as HCF (standing for “high cycle fatigue”).

For example, the mechanical weakening of the surfaces S1 to S10 may have a mechanical weakening of between 40% and 50%.

The mechanical weakening of the connecting surfaces R1 and R3 may also have a mechanical weakening of between 40% and 50%.

The surface S12 and the other surfaces of the connecting wall opposite to the surfaces S1 to S10 may have a mechanical weakening of less than 20%, in particular less than 15%.

The method 200 comprises a step 204 for determining a maximum roughness for each of the surfaces S1-S11 and R1-R3 according to the mechanical weakening provided at the preceding step 202.

The method 200 next comprises:
a step 206 for determining a total maximum roughness according to the maximum roughnesses determined at step 204 and optionally the target roughnesses supplied, and
a step 208 for determining the orientation of the axis X with respect to the manufacturing platen of the additive manufacturing device according to the total maximum roughness determined at step 206.

The orientation of the axis X on the manufacturing platen is determined at step 208 using a first experimental law 500 linking the roughness of an outer surface of a part and an angle of manufacture of the part with respect to the manufacturing platen.

Step 204 is implemented using a second experimental law 600 linking roughness and mechanical weakening.

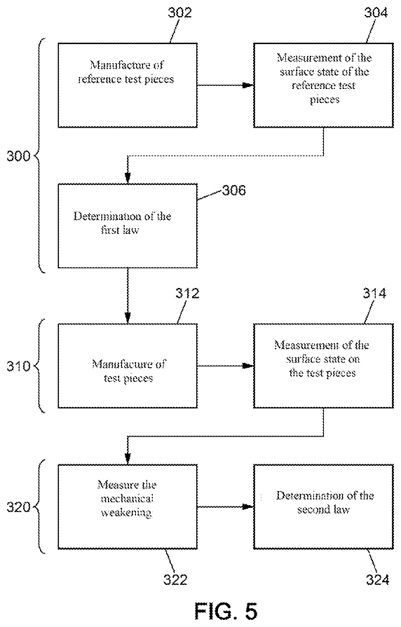

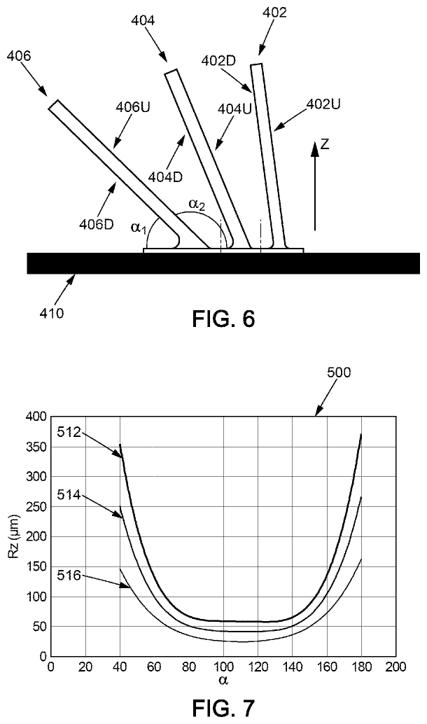

With reference to FIGS. 5 to 8, the method 300 makes it possible to obtain the first experimental law 500 and the method 320 makes it possible to obtain the second experimental law.

The method comprises a step 302 of manufacturing a plurality of reference specimens 402, 404 and 406, by additive manufacturing. For example, the reference specimens 402, 404 and 406 produced from the same material, such as nickel or titanium, by the same additive manufacturing device.

Each of the specimens 402, 404 and 406 is inclined with respect to the axis Z, which is perpendicular to the manufacturing platen 410. Each of the specimens 402, 404 and 406 has, respectively, a bottom surface 402D, 404D and 406D and a top surface 402U, 404U and 406U opposite to the corresponding bottom surface 402D, 404D and 406D. Each bottom surface 402D, 404D and 406D forms a first angle α₁ with the plane of the manufacturing platen 410, of approximately 80°, 70° and 45° respectively.

Each top surface 402U, 404U and 406D forms a second angle α₂ with the plane of the manufacturing platen 410, complementary to the first angle α₁ of the bottom surface 402D, 404D et 406D, respectively.

The method 300 comprises measuring the roughness R_{z} of each of the top and bottom surfaces of the reference specimens 402, 404 and 406. The roughness is an arithmetic mean roughness of the profile measured by a profile meter with or without contact.

For each reference specimen 402, 404 and 406, several models are manufactured with the same material and the same angles α₁ and α₂ and roughness data are measured for each of these models.

The first experimental law 500 is obtained at step 306 by interpolating these roughness data and links the roughness R_{z} and the manufacturing angle α. The first experimental law 500 comprises a curve 514 interpolating the mean of the roughness data, the curve 512 interpolating the roughness data at standard deviations of approximately +2 of the roughnesses mean, and the curve 514 interpolating the roughness data at standard deviations of approximately −2 of the roughnesses mean.

The curves 510, 512 and 514 of the first experimental law 500 are obtained by a polynomial interpolation.

The manufacturing angle α corresponds to the first angle α₁ when it is less than 90° and to the second angle α₂ when it is greater than 90°.

The first experimental law 500 can be stored in a database.

The first experimental law 500 can be validated by a method 310 comprising the production 312 of test pieces by additive manufacturing. For example, these test pieces can comprise an external surface extending along a plane inclined to the plane of the manufacturing platen with a manufacturing angle that can be different from the first angle α₁ and second angle α2. For example, the manufacturing angle can be equal to 40°, 50°, 70° and 90°.

The method 310 next comprises, for each test piece, measuring the roughness of the external surface. This measured roughness is compared with a roughness calculated by the first experimental law 500 for the manufacturing angle of the test piece. The first experimental law 500 can be corrected according to the roughnesses measured on the test pieces.

To determine the second experimental law 600, the method 320 comprises measuring the mechanical weakening of the test pieces and/or of the reference specimens at various temperatures, for example at 20° and at 750°.

In a similar manner to the construction of the first experimental law 500, for each reference or test piece, several models are manufactured with the same material and the same angles, mechanical weakening data being measured for each of these models.

The second experimental law 600 is obtained at step 324 by interpolating these mechanical weakening data and the mechanical weakening and the roughness R_{z}.

For a temperature of approximately 20°, the second experimental law 600 comprises a curve 604 interpolating the mean of the mechanical weakening data.

For a temperature of approximately 750°, the second experimental law 600 comprises a curve 608 interpolating the mean of the mechanical weakening data.

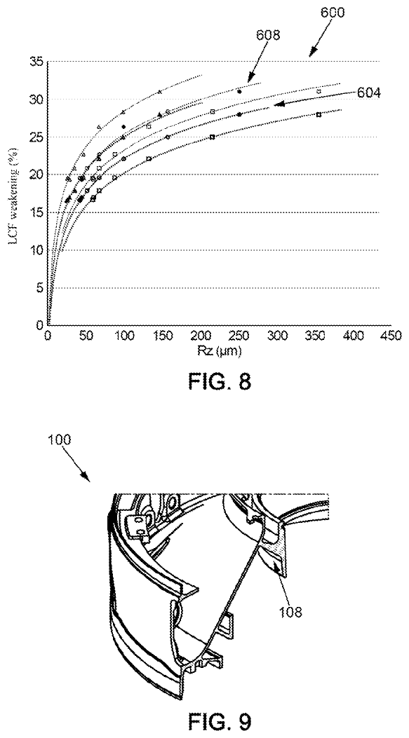

The sampling points shown by squares, triangles and circles on FIG. 8 correspond to the measurements of the mechanical weakening.

The method 200 comprises a step 210 of validating the orientation of the axis X with respect to the manufacturing platen.

This step 210 can comprise, for each of the inclined surfaces S1-S11 and R1-R3, the substeps:
comparing the target roughness and the maximum roughness,
when the total maximum roughness is greater than the target roughness S1-S11 and R1-R3, modifying the dimensioning of said inclined surface S1-S11 and R1-R3 by adding a thickness thereto.

Step 210 can comprise, for each of the inclined surfaces S1-S11 and R1-R3, the substeps:
comparing the target roughness and the maximum roughness,
when the total maximum roughness is greater than the target roughness of said inclined surface S1-S11 and R1-R3, modifying the dimensioning of the inclined portion S1-S11 and R1-R3 by modifying the angle between the inclined surface and the axis X.

As shown on FIG. 9, the angle of the rib 108 is modified since the total maximum roughness that will be obtained at the end of the additive manufacturing is different from the target roughness of the surfaces S1 and R1.

The method 200 can next comprise a return to step 202 with new mechanical characteristics of the bearing support 100, i.e. a new angle of inclination of the rib 108.

Finally, the method 200 comprises a step 212 of producing the bearing support 100 by additive manufacturing. For this purpose, the bearing support 100 will be oriented so that the axis X is perpendicular to the plane of the manufacturing platen 410 and so that the surface S11 is turned towards the manufacturing platen.

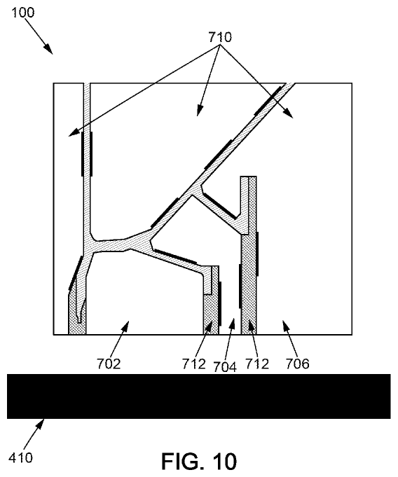

For this purpose, honeycomb supports 712, as shown on FIG. 10, are disposed under the parts at a distance from the manufacturing platen 410 to avoid the bearing support 100 collapsing during manufacture. These supports 712 can be removed manually or by machining.

FIG. 9 shows the bearing support 100 as obtained by additive manufacturing.

The method 200 can comprise the machining of one or more inclined surfaces to obtain the target roughness as determined at step 210.

For example, the surfaces of the region 702 are adjusted by machining and next polished by sanding.

The surfaces of the regions 704, 706 and 710 may be solely polished by sanding.

The machining may furthermore be implemented by milling or by polishing such as chemical polishing, tribofinishing, polishing by abrasive paste, sanding, etc.

The added thickness determined at step 210 may be dependent on the type of machining.

1.-9. (canceled)

10. Method for additive manufacturing of a turbomachine part, said turbomachine part having a primary axis and at least one inclined portion extending in a secondary direction forming a non-zero angle with the primary axis, the method comprising the steps of:
for each inclined portion of the at least one inclined portion:
providing a target roughness of an outer surface of said inclined portion;
providing a mechanical weakening of said inclined portion; and
determining a maximum roughness of the outer surface of said inclined portion according to the mechanical weakening of said inclined portion;
determining a total maximum roughness according to the maximum roughness of the outer surface of each inclined portion,
determining, according to the total maximum roughness, an orientation of the primary axis of the turbomachine part with respect to a plane of a manufacturing platen of an additive manufacturing device, and
producing the turbomachine part by additive manufacturing.

11. Method according to claim 10, comprising determining a first experimental law by:
supplying reference specimens, each reference specimen having a primary axis and being produced by additive manufacturing, each reference specimen comprising a bottom surface facing the manufacturing platen of the manufacturing device forming a first angle with the primary axis and a top surface opposite to said bottom surface and forming a second angle with the primary axis;
for each reference specimen, measuring the roughness of the top surface and the roughness of the bottom surface; and
obtaining said first experimental law by interpolating the roughnesses of the top surface and of the bottom surface according to the first angles and the second angles.

12. Method according to claim 11, wherein determining an orientation of the primary axis comprises determining the orientation of the primary axis of the turbomachine part using the first experimental law.

13. Method according to claim 11, comprising determining a second experimental law by:
for each reference specimen, measuring the mechanical weakening and the roughness of at least one of: the bottom surface; and the top surface; and
obtaining said second experimental law by interpolating the mechanical weaknesses according to the roughnesses.

14. Method according to claim 13, wherein determining a total maximum roughness comprises determining the total maximum roughness using the second experimental law.

15. Method according to claim 10, further comprising, for each inclined portion of the at least one inclined portion:
comparing the target roughness to the total maximum roughness; and
if the total maximum roughness is greater than the target roughness of said inclined portion, machining said inclined portion to obtain the target roughness, after producing the turbomachine part by additive manufacturing.

16. Method according to claim 15, further comprising at least one of: polishing the inclined portion; and milling the inclined portion.

17. Method according to claim 10, further comprising, for each inclined portion:
comparing the target roughness to the total maximum roughness; and
if the total maximum roughness is greater than the target roughness of said inclined portion, modifying a dimensioning of the inclined portion by adding a thickness thereto prior to producing the turbomachine part by additive manufacturing.

18. Method according to claim 10, wherein the turbomachine part is one of: a bearing structure of a turbomachine: a turbine blade of a turbomachine; and a compressor blade of a turbomachine.
